(19) United States
(12) Patent Application Publication
(10) Pub. No.: US 2025/0345229 A1
(43) Pub. Date: Nov. 13, 2025

(54) ISCHIAL BEARING CRUTCH

(71) Applicant: Alberto Casses, Ontario (CA)

(72) Inventor: Alberto Casses, Ontario (CA)

(21) Appl. No.: 19/204,083

(22) Filed: May 9, 2025

Related U.S. Application Data
(60) Provisional application No. 63/645,539, filed on May 10, 2024.

(51) Int. Cl. A61H 3/02

(52) U.S. Cl. CPC A61H 3/02

(57) ABSTRACT

An ischial bearing crutch assists a person in walking or standing. The ischial bearing crutch includes an upright support member, a saddle connected to an upper end of the upright support member, the saddle being shaped to support the person, a handle extending forwardly from the saddle, an upper leg restraint for restraining an upper leg relative to the upright support member and a lower leg restraint for restraining a lower leg relative to the upright support member.

### CROSS-REFERENCE TO RELATED APPLICATION

This application claims priority to U.S. Provisional Patent Application No. 63/645,539, filed May 10, 2024, the disclosure of which is incorporated herein by reference in its entirety.

### TECHNICAL FIELD

The present invention relates generally to mobility aids and, more particularly, to crutches.

### BACKGROUND

Numerous types of crutches are known for providing mobility to those recovering from surgery or for those who suffer from infirmities, injuries, and/or handicaps. A conventional crutch design is supported under the armpit of the person and requires at least one hand to grip a handle of the crutch. This conventional crutch design leaves the person with only one hand to perform other tasks. It would be highly desirable to provide an improved crutch that frees both of the person's hands while still using the crutch.

### SUMMARY

In general, the specification discloses an ischial bearing crutch that is an improvement over the prior art. A main aspect of this disclosure is an ischial bearing crutch that assists a person in walking or standing. The ischial bearing crutch includes an upright support member, a saddle connected to an upper end of the upright support member, the saddle being shaped to support the person, a handle extending forwardly from the saddle, an upper leg restraint for restraining an upper leg relative to the upright support member and a lower leg restraint for restraining a lower leg relative to the upright support member.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWINGS

Further features and advantages of the present invention will become apparent from the following detailed description, taken in combination with the appended drawings, in which:

FIG. 1 is a side view of an ischial bearing crutch in accordance with an embodiment of the present invention;

FIG. 2 is a view of an upper portion of the crutch in accordance with an embodiment of the present invention; and

FIG. 3 is a view of a lower portion of the crutch in accordance with an embodiment of the present invention.

It will be noted that throughout the appended drawings, like features are identified by like reference numerals.

### DETAILED DESCRIPTION

Disclosed herein is an ischial bearing crutch that helps a person to walk or stand. The ischial bearing crutch can be used as a hands-free crutch. As described in detail below, the ischial bearing crutch supports the person via the ischial tuberosity. The person thus does not need to support his or her weight using an armpit and hand as traditionally done with conventional crutches. Also, the ischial bearing crutch provides full support for the person as a single crutch instead of requiring a pair of crutches to fully support a person.

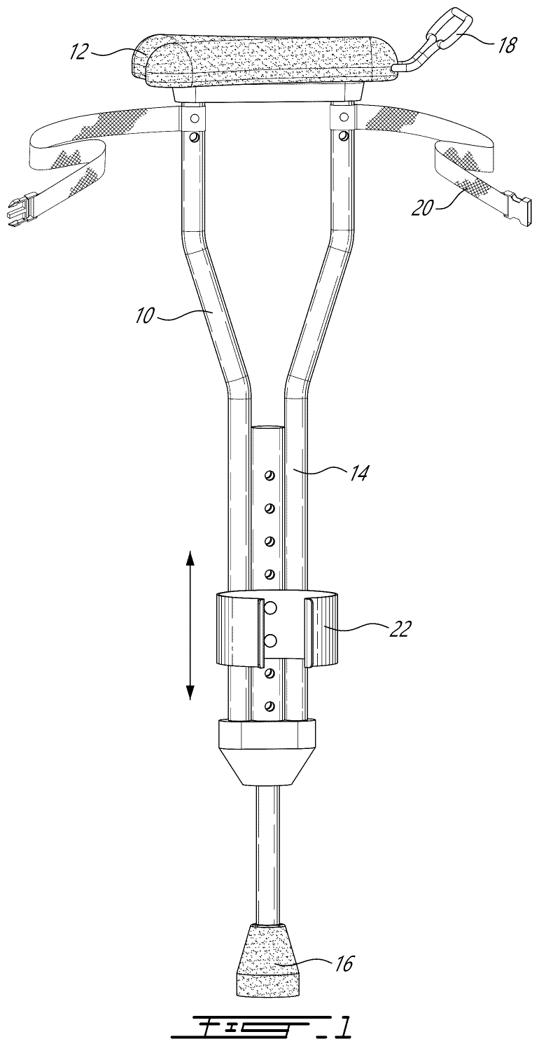

In the embodiment depicted by way of example in FIGS. 1-3, the ischial bearing crutch denoted generally by reference numeral 10 has a saddle 12 mounted to a generally upright elongated support member 14 at an upper end of the support member 14. The support member 14 may optionally be extendable/retractable to lengthen or shorten the support member so that the crutch can be adjusted to accommodate a taller or shorter person as the case may be. In one specific example, the support member 14 may be telescopic. In the specific example of the support member being telescopic, the support member 14 may have a tubular member and an internal rod, shaft or pole that slides inside the tubular member relative to the tubular member to extend or retract the support member. As shown by way of example in FIG. 1, the upright support member 14 may have a cylindrical or tubular lower portion 14a and a Y-shaped intermediate frame portion 14b and an upper frame portion having two parallel upright frame members 14c. The crutch may have different geometries in other embodiments. The upright support member may be made of aluminum tubing or any other suitable metal, wood, polymer or composite material or any suitable combination of materials.

As depicted by way of example in FIGS. 1-3, the ischial bearing crutch 10 may have a ground-engaging foot or heel 16 mounted at a lower end of the support member. The ground-engaging foot or heel 16 may be rubber or rubberized (or be made of any other suitable elastomer or polymer) to provide a grip on the ground to avoid slippage. The ground-engaging foot or heel may be referred to as a non-slip foot.

As depicted by way of example in FIGS. 1-3, the saddle 12 may be a seat that is shaped, for example, like a bicycle seat with a narrow portion in the front and a wider portion in the rear. The saddle may be pear-shaped (when viewed from the top) with a narrow nose in the front and a wide (flared) portion in the rear. Alternatively, the saddle 12 may be a unicycle seat or unicycle saddle. The saddle 12 may be replaced with any other suitably shaped seat so long as it provides weight-bearing support for the person. The saddle may be padded. The saddle may have a foam interior and a leather or vinyl exterior (or an exterior made of any other suitable material). The saddle 12 is designed to primarily or mainly support the person by the ischial tuberosity, also known more informally as the sitting bone. The ischial tuberosity is a large protruberance on the ischium. The ischium is a pelvic bone that forms the lower and back part of the hip bone. When a person sits, the weight of the person often bears on the ischial tuberosity. The ischial bearing crutch thus supports the person by the ischial tuberosity of the person. However, it will be appreciated that the ischial bearing crutch can still provide support even if the person sits in different postures, i.e. even if the weight of the person does not bear purely or directly on the ischial tuberosity.

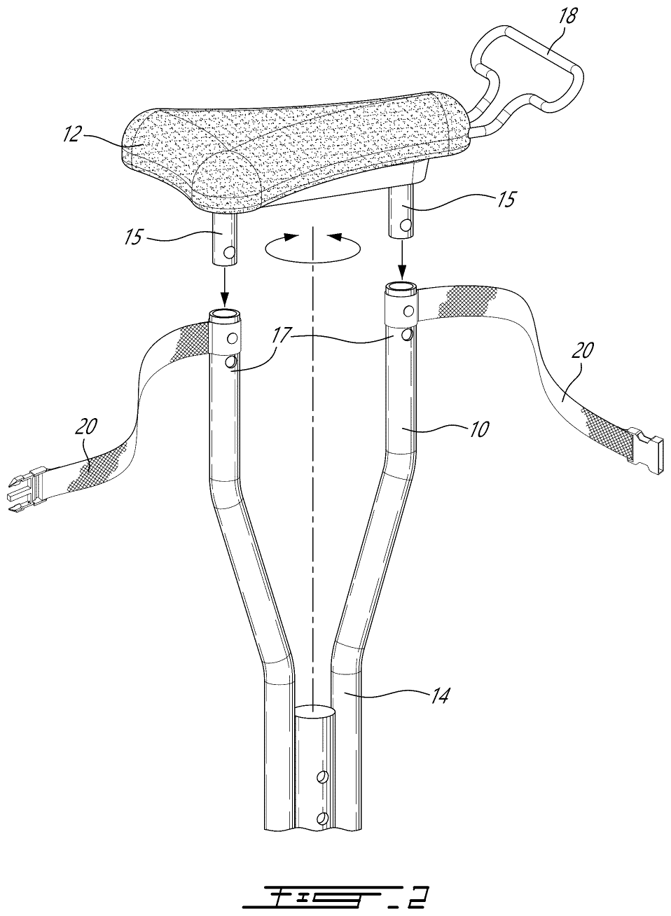

In one embodiment, the saddle is a reversible saddle that is detachably secured to the upright support member. The reversible saddle is useful because it permits the person, or any medical personnel assisting the person, to reconfigure the ischial bearing crutch for the left leg or the right leg. Accordingly, there is no need to manufacture or stock crutches specifically for left legs and right legs. In one specific embodiment, the reversible saddle comprises an attachment mechanism for attaching the saddle to the upright support member. For example, as shown by way of example in FIG. 2, the reversible saddle comprises two downwardly extending poles 15 (shafts, rods or elongated anchors) that fit into two upwardly oriented tubes 17 of the support member. As depicted by way of example in FIG. 2, the poles 15 may have holes that align with corresponding holes in the upwardly oriented tubes 17. Fasteners may be inserted through the holes in the poles 15 and upwardly oriented tubes 17 to thereby secure the saddle to the upright support member. Other fastening mechanisms, e.g. locking pins, clamps, clips, quick-connect cam-locks, etc., may be substituted to secure the saddle to the upright support member.

As depicted by way of example in FIGS. 1-3, the ischial bearing crutch 10 may include a handle 18 connected to a front of the saddle. The handle may extend forward of the saddle. The handle may also extend upwardly as shown. The handle 18 may be gripped or grasped by the person to steer or direct the crutch when walking. The handle may define a closed loop as shown or it may be in another shape.

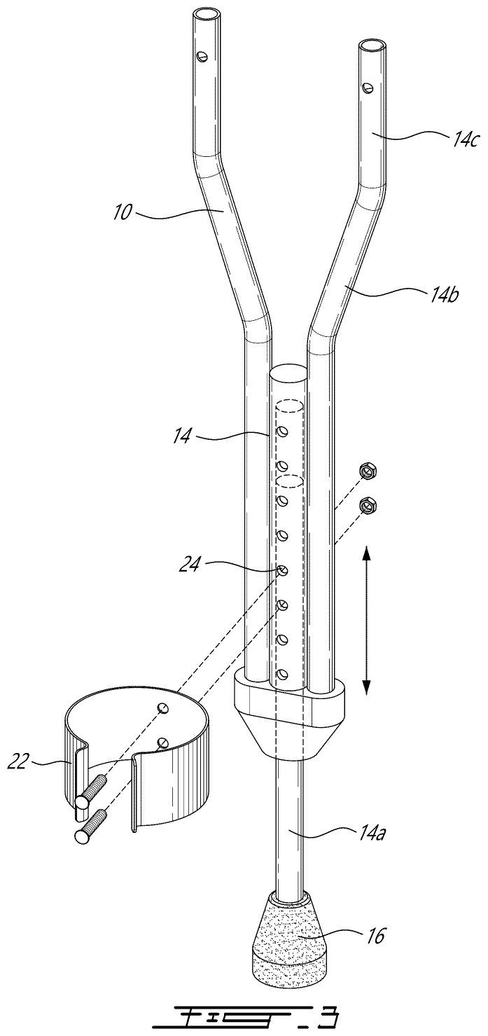

The ischial bearing crutch 10 may include one or more leg restraints to restrain the leg relative to the ischial bearing crutch. For example, as shown in the embodiment illustrated in the figures, there may be an upper leg restraint 20 and a lower leg restraint 22. More specifically, in one embodiment, the upper leg restraint 20 may be thigh strap to restrain the thigh whereas the lower leg restraint 22 may be a lower leg/calf/ankle cuff, clamp or brace 22 that restrains the lower leg and/or ankle. The thigh strap 20 may be an adjustable strap to provide a comfortable yet secure tightness around the thigh. The lower leg/calf/ankle brace 22 may be a clamp that is fastened by fasteners 24 to the support as shown by way of example in FIG. 3. The brace 22 may be a ratchet buckle or ratchet strap (similar to the ratchet buckle used on downhill ski boots). The fasteners 24 may be screws, bolts or another other suitable fastening device or mechanism to fasten, secure or lock the brace 22 to the upright support member. The brace 22 may be vertically adjustable along the upright support member. In other words, the brace may be fastened to different holes in the upright support member to adjust the placement of the brace along the upright support member.

In operation, the upright support member 14 of the ischial bearing crutch is lengthened to a length that ensures that the foot of the leg supported by the ischial bearing crutch clears the ground so that no weight is put on the leg while the person is walking or standing with the ischial bearing crutch. In other words, the weight of the person is shared by the person's good leg and the ischial bearing crutch. Specifically, part of the weight of the person sitting on the saddle bears on the upright support member to transfer this part of the person's weight to the ground. The person using the ischial bearing crutch can walk or stand while keeping both hands free. A hand is only needed to occasionally steer or direct the ischial bearing crutch via the handle. Otherwise, the person using the ischial bearing crutch has both hands free to perform other manual tasks. This provides a significant improvement over the prior art.

Furthermore, no part of the crutch 10 engages or bears against the armpit of the person using the crutch. The crutch 10 thus avoids the traditional problem of pain or discomfort to the armpit caused by armpit-bearing crutches.

In another implementation, there may be a smaller or paediatric version of the ischial bearing crutch to be used by children, e.g. children aged 5 to 12. Usually, children between ages 5 and 7 have trouble walking with two crutches. The single ischial bearing crutch may resolve or at least partially mitigate this issue.

In another implementation, the ischial bearing crutch may optionally include a strap around the shoulder of the person using the crutch to provide a fully handsfree experience. This implementation of ischial bearing crutch would eliminate the need to include the handle for steering or directing the crutch.

In another implementation, the ischial bearing crutch can be manufactured by modifying a single conventional armpit crutch by replacing the upper portion that engages the armpit with a seat or saddle and a mounting interface that mounts the seat or saddle to the conventional armpit crutch. The thigh strap 20 and the brace 22 can be attached to the crutch. A handle can be attached to the crutch. The seat can be, for example, a unicycle seat as mentioned above. Thus, the present disclosure also provides a method of converting or transforming a single conventional armpit crutch into an ischial bearing crutch. By performing these modifications, conventional armpit crutches can thus be repurposed as ischial bearing crutches.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This invention has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. An ischial bearing crutch to assist a person in walking or standing, the ischial bearing crutch comprising:
an upright support member;
a saddle connected to an upper end of the upright support member, the saddle being shaped to support the person;
a handle extending forwardly from the saddle;
an upper leg restraint for restraining an upper leg relative to the upright support member; and
a lower leg restraint for restraining a lower leg relative to the upright support member.

2. The crutch of claim 1 wherein the saddle supports the person via the ischial tuberosity.

3. The crutch of claim 1 wherein the upper leg restraint is an adjustable thigh strap.

4. The crutch of claim 1 wherein the lower leg restraint is a calf/ankle brace.

5. The crutch of claim 4 wherein the calf ankle brace is fastened by fasteners to the upright support member.

6. The crutch of claim 1 comprising a non-slip foot connected to a lower end of the upright support member.

7. The crutch of claim 1 wherein the upright support member is extendable and retractable.

8. The crutch of claim 1 wherein the upright support member is telescopic.

9. The crutch of claim 1 wherein the saddle is a reversible saddle that is detachably secured to the upright support member.

10. The crutch of claim 9 wherein the reversible saddle comprises two downwardly extending poles that fit into two upwardly oriented tubes of the support member.

11. The crutch of claim 1 wherein the handle also extends upwardly.

12. The crutch of claim 10 wherein the handle defines a closed loop.

13. A crutch comprising:
an upright support member having an upper end and a lower end;
a seat connected to the upper end of the upright support member, the seat being shaped to support the person;
an upper leg restraint for restraining an upper leg relative to the upright support member; and
a lower leg restraint for restraining a lower leg relative to the upright support member.

14. The crutch of claim 13 comprising a handle extending forwardly from the seat.

15. The crutch of claim 13 wherein the seat supports the person via the ischial tuberosity.

16. The crutch of claim 13 wherein the upper leg restraint is an adjustable thigh strap.

17. The crutch of claim 13 wherein the lower leg restraint is a calf/ankle brace comprising a ratchet buckle.

18. The crutch of claim 13 wherein the upright support member is extendable and retractable.

19. The crutch of claim 13 wherein the upright support member is telescopic.

20. The crutch of claim 13 wherein the seat supports the person via the ischial tuberosity, wherein the upper leg restraint is an adjustable thigh strap, and wherein the lower leg restraint is a brace comprising a ratchet buckle.
